(19) United States
(12) Patent Application Publication
(10) Pub. No.: US 2025/0340059 A1
(43) Pub. Date: Nov. 6, 2025

(54) CAP DEVICE

(71) Applicant: Roland DG Corporation, Hamamatsu-shi (JP)

(72) Inventors: Kota KASHIWAGI, Hamamatsu-shi (JP); Akira SUWADA, Hamamatsu-shi (JP); Kazuhiro IDA, Hamamatsu-shi (JP)

(21) Appl. No.: 19/269,174

(22) Filed: Jul. 15, 2025

Related U.S. Application Data
(63) Continuation of application No. PCT/JP2023/002196, filed on Jan. 25, 2023.

(51) Int. Cl. B41J 2/165

(52) U.S. Cl. CPC B41J 2/16508; B41P 2235/27

(57) ABSTRACT

A cap device includes a contact assembly surrounding an absorber and movable into contact with an ejection portion. When the contact assembly is separated from the ejection portion, a gap is provided between an absorber corner surface and a contact corner surface.

### CROSS REFERENCE TO RELATED APPLICATIONS

This application is a Continuation Application of PCT Application No. PCT/JP2023/002196 filed on Jan. 25, 2023. The entire contents of this application are hereby incorporated herein by reference.

### BACKGROUND OF THE INVENTION

### 1. Field of the Invention

The present invention relates to cap devices to close ink ejection portions.

### 2. Description of the Related Art

Examples of a printer include an inkjet printer including an ejection portion that ejects ink on a print medium. When such a printer is not in operation, the ejection portion is closed by a cap device such that the ink remaining in ejection ports formed in the ejection portion do not dry out. The conventional art related to a cap device is disclosed in Japanese Patent No. 6203977.

A cap device disclosed in Japanese Patent No. 6203977 includes an absorber capable of absorbing ink ejected from an ejection portion capable of ejecting the ink, and a contact assembly which houses the absorber, and the upper end of which can come into close contact with the ejection portion.

When the contact assembly is brought into close contact with the ejection portion for ink, a space surrounded by the ejection portion and the contact assembly becomes a sealed space. When a suction pump connected to the sealed space is driven in a state in which the sealed space is formed, the ink remaining in the ejection portion can be suctioned therefrom.

### SUMMARY OF THE INVENTION

When the suction pump is driven, the internal pressure in the sealed space becomes negative pressure. When a portion in close contact with the ejection portion for ink is deformed to collapse toward the inside of the sealed space, the close contact of the contact assembly is affected, and an improvement is required.

Example embodiments of the present invention provide cap devices each including a contact assembly providing very close contact with an ejection portion for ink.

According to an example embodiment of the present invention, a cap device includes an absorber to absorb ink ejected from an ejection portion capable of ejecting the ink, and a contact assembly surrounding the absorber and movable into contact with the ejection portion, the cap device being configured to suction the ink absorbed in the absorber when the contact assembly is in contact with the ejection portion. The absorber includes a facing surface that faces the ejection portion, and when the absorber is viewed in a direction facing the facing surface, a gap is defined between a corner of the absorber and a corner of the contact assembly when the contact assembly is separated from the ejection portion.

According to an example embodiment of the present invention, preferably, both the corner of the absorber and the corner of the contact assembly are curved surfaces, and a radius of the corner of the absorber is larger than a radius of the corner of the contact assembly.

Example embodiments of the present invention provide cap devices each including a contact assembly providing very close contact with the ejection portion for ink.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a perspective view of a printer including a cap device according to an example embodiment, and FIG. 1B is a view describing an ejection portion included in the printer illustrated in FIG. 1A.

FIG. 2 is a perspective view of the ejection portion capable of ejecting ink and the cap device capable of closing the ejection portion.

FIG. 3 is a cross-sectional view taken along line 3-3 in FIG. 2.

FIG. 4A is a plan view of the cap device, and FIG. 4B is an enlarged view of a portion surrounded by line 4B in FIG. 4A.

FIG. 5A is an action view of a contact assembly when a pump is operated, and FIG. 5B is an enlarged view of a portion surrounded by line 5B in FIG. 5A.

### DETAILED DESCRIPTION OF THE EXAMPLE EMBODIMENTS

Example embodiments of the present invention will be described below with reference to the accompanying drawings. Incidentally, in the description, the left and right refer to the left and right with respect to a state in which a user faces a printer, and the front and rear refer to the front and rear with respect to a paper feed direction of the printer. The up and down refers to a nominal direction of a floor on which the printer is placed. In addition, in the figures, Fr, Rr, Le, Ri, Up, and Dn represent the front, the rear, the left, the right, the top or up, and the bottom or down, respectively.

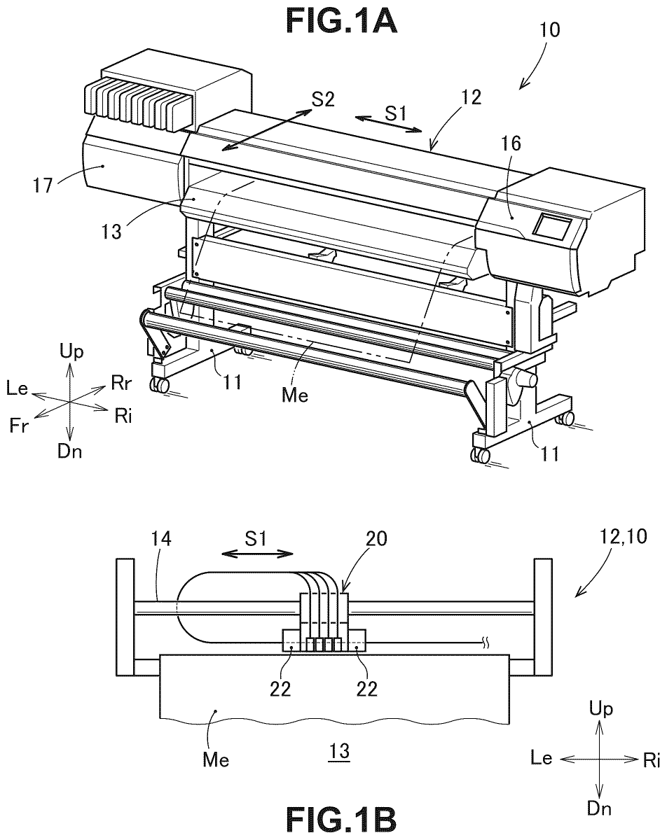

Referring to FIG. 1A, a printer 10 includes left and right leg portions 11 and 11 provided with casters, and a printing unit 12 supported by the leg portions 11 and 11 and capable of performing printing. Incidentally, the printer 10 may not include casters on the leg portions 11 and 11, and may include only the printing unit 12.

Referring also to FIG. 1B, the printing unit 12 includes a table portion 13 which is provided at the center of the printing unit 12, and on which a print medium Me such as paper can be placed, a rail 14 extending in a left-right direction above the table portion 13, an ink ejection unit 20 provided to be movable on the rail 14 (see arrow S1) and capable of ejecting ink, and lid portions 16 and 17 provided at left and right end portions and capable of swinging in an up-down direction.

The rail 14 extends to portions covered by the lid portions 16 and 17. The ink ejection unit 20 is movable from above the table portion 13 to the portions covered by the lid portions 16 and 17.

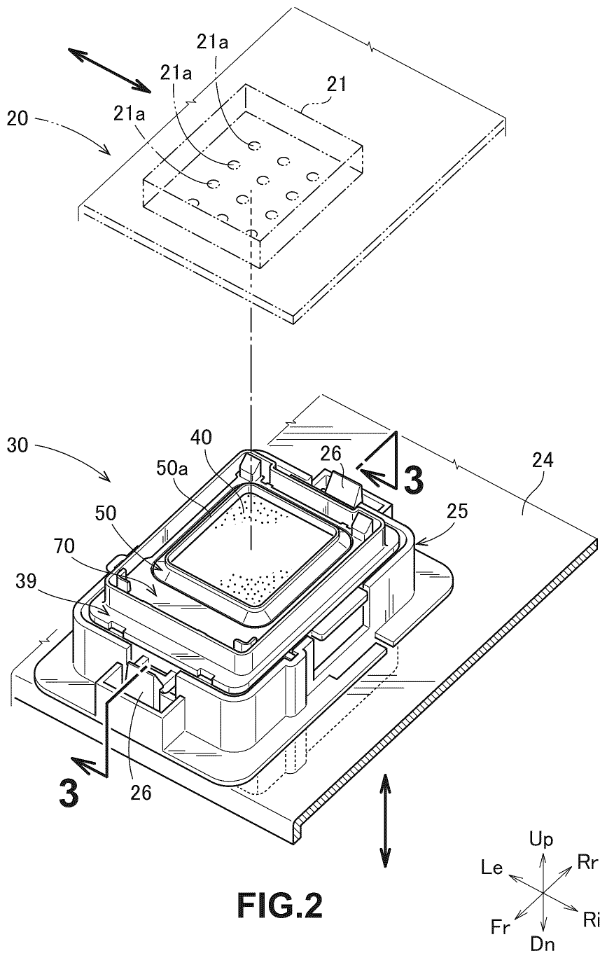

Referring to FIG. 1B and FIG. 2, the ink ejection unit 20 includes an ejection portion 21 in which ejection ports 21a capable of ejecting ultraviolet-curable ink are provided, and a lamp 22 that irradiates the ejected ink with ultraviolet light.

For example, when the print medium Me is paper, the paper is fed on an upper surface of the table portion 13 from the rear toward the front (see arrow S2 in FIG. 1A). The ink ejection unit 20 ejects the ultraviolet-curable ink toward the paper while moving in the left-right direction (see arrow S1). The ejected ink is irradiated with ultraviolet light by the ultraviolet lamp 22, so that the ink is cured. Accordingly, a predetermined pattern or the like can be printed on the paper.

Incidentally, the print medium Me may be a medium other than paper, and ink other than ultraviolet-curable ink can also be adopted.

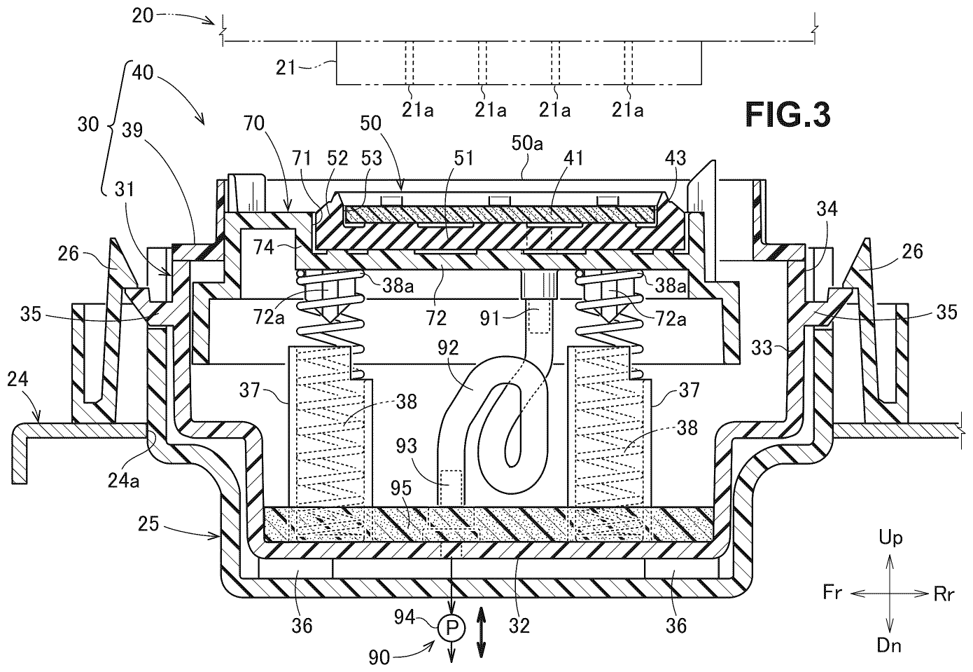

Referring to FIG. 2 and FIG. 3, in the portion covered by the lid portion 16 (see FIG. 1A), a lifting portion 24 having a plate shape that can be raised and lowered by a drive mechanism (not illustrated), a box 25 that is fitted into a fitting hole 24a in the lifting portion 24 and that opens upward, a cap device 30 attached to the box 25 and capable of closing the ejection ports 21a, and a suction device 90 capable of suctioning the ink are provided. Incidentally, the number or shape of the cap devices 30 can be appropriately changed to match the ejection portion 21.

The drying of the ink with which the ejection portion 21 is filled can be reduced or prevented by moving the lifting portion 24 upward to bring the cap device 30 into close contact with the ejection portion 21.

The cap device 30 includes a cap unit 40 capable of covering the ejection portion 21, a casing body 31 that houses the cap unit 40, and a restriction member 39 that restricts the position of the cap unit 40 housed in the casing body 31.

The casing body 31 has a cup shape with an open top. The casing body 31 includes a casing bottom portion 32 and a casing peripheral wall portion 33 extending upward from a peripheral edge of the casing bottom portion 32. The casing peripheral wall portion 33 has a stepped shape, and the upper side of the casing peripheral wall portion 33 opens more widely.

Both the box 25 and the casing body 31 are made of resin, and can be attachable to and detachable from each other by snap fitting. The casing peripheral wall portion 33 includes two locking portions 35 and 35 protruding outward from an outer peripheral surface 34 thereof. The box 25 includes two locked portions 26 and 26 that can be locked to the locking portions 35 and 35.

The casing bottom portion 32 includes a plurality of casing leg portions 36 and 36 extending downward from the casing bottom portion 32, and a plurality of cylindrical portions 37 and 37 extending upward from the casing bottom portion 32. A compression coil spring 38 is housed in each of the cylindrical portions 37. An upper end 38a of each of the compression coil springs is exposed. A fitting portion 72a on a fixing member 70 to be described later is fitted to an inner peripheral surface of the upper end 38a. With such a configuration, the cap unit 40 is movable up, down, left, and right.

The restriction member 39 has a frame shape, and is fixed to an upper end of the casing peripheral wall portion 33.

The cap unit 40 includes an absorber 41 having a plate shape and capable of absorbing the ink ejected from the ejection portion 21, a contact assembly 50 which houses the absorber 41 and an upper end 50a of which can come into close contact with the ejection portion 21, and the fixing member 70 to which the contact assembly 50 is fixed.

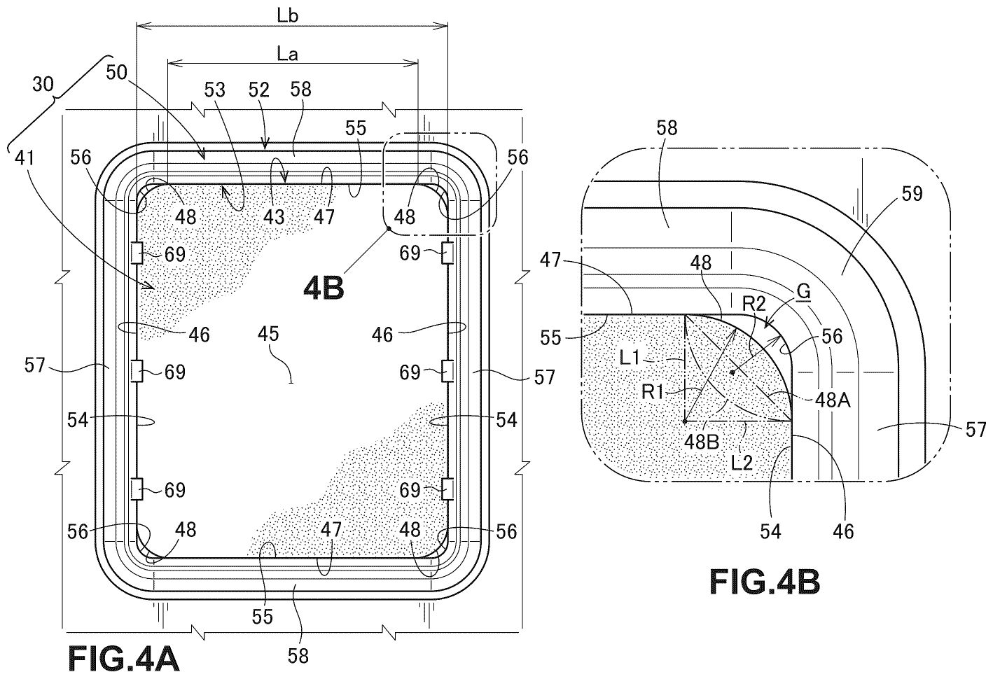

Referring to FIG. 3 and FIGS. 4A and 4B, the absorber 41 has a facing surface 45 facing the ejection portion 21. When the absorber 41 is viewed in a direction facing the facing surface 45 (the state illustrated in FIG. 4A), the absorber 41 has a rectangular or rectangular shape, and the size of the absorber 41 corresponds to the size of the ejection portion 21. The material of the absorber 41 is, for example, sponge, and a known material can be appropriately adopted.

A side surface 43 of the absorber 41 includes a pair of longitudinal surfaces 46 and 46 extending in a longitudinal direction of the absorber 41, and a pair of lateral surfaces 47 and 47 extending in a lateral direction of the absorber 41. Both the longitudinal surfaces 46 and 46 and the lateral surfaces 47 and 47 are flat surfaces.

Referring to FIG. 3 and FIGS. 4A and 4B, the contact assembly 50 is made of, for example, rubber, and is formed by integrating a bottom portion 51 capable of supporting the absorber 41 and a peripheral wall portion 52 having a frame shape and extending upward from a peripheral edge of the bottom portion 51.

The peripheral wall portion 52 includes a plurality of holding portions 69 that hold the absorber 41 housed in the contact assembly 50. The holding portions 69 protrude from an upper surface of the peripheral wall portion 52 toward the inside of the peripheral wall portion 52, come into contact with the facing surface 45 of the absorber 41, and restrict the upward movement of the absorber 41. The holding portions 69 are provided to face each other within the peripheral wall portion 52 (see FIG. 4A), and the number and position of the holding portions 69 can be changed as appropriate.

The peripheral wall portion 52 of the contact assembly 50 has a surrounding surface 53 having a rectangular or substantially rectangular shape and surrounding the side surface 43 of the absorber 41 over the entire periphery. The surrounding surface 53 includes first contact surfaces 54 and 54 in contact with the pair of longitudinal surfaces 46 and 46 of the absorber 41, and second contact surfaces 55 and 55 in contact with the pair of lateral surfaces 47 and 47 of the absorber 41.

Referring to FIG. 4B, the longitudinal surface 46 and the lateral surface 47 adjacent to each other are connected by an absorber corner surface 48 (a corner of the absorber 41). The absorber corner surface 48 is a curved surface. The first contact surface 54 and the second contact surface 55 adjacent to each other are connected by a contact corner surface 56 (a corner of the contact assembly 50). The contact corner surface 56 is a curved surface. A radius R1 of the absorber corner surface 48 is larger than a radius R2 of the contact corner surface 56.

When the contact assembly 50 is separated from the ejection portion 21, a gap G is set between the absorber corner surface 48 and the contact corner surface 56. In other words, the absorber 41 is configured such that the corner portions are cut out. Incidentally, as long as the gap G is set, the absorber corner surface may be a flat surface such as an absorber corner surface 48A, or may have any shape as long as the absorber corner surface is not located on the center side of the absorber 41 with respect to lines L1 and L2 drawn perpendicularly to the peripheral wall portion 52 from the point where the peripheral wall portion 52 and the absorber 41 separate from each other (see line 48B). In addition, it is preferable that the gap G is provided such that the absorber 41 comes into contact with the peripheral wall portion 52 of the contact assembly 50 within a range in which the peripheral wall portion 52 does not collapse inward when suction is performed. Specifically, a contact length La that the side surface (for example, the lateral surface 47) of the absorber 41 comes into contact with the peripheral wall portion 52 is preferably about 80% or more, more preferably about 90% or more of the length of one side of the peripheral wall portion 52. In addition, it is preferable that the gap G is provided such that the peripheral wall portion 52 and the absorber 41 do not come into contact with each other at the rounded portion of each corner of the contact assembly 50.

Incidentally, the above description is a description regarding the upper right corner portion of the cap device 30 illustrated in FIG. 4A. However, the description also applies to the other three corners of the cap device 30.

Referring to FIG. 3, the suction device 90 includes an upper discharge portion 91 inserted into a hole in the bottom portion 51 of the contact assembly 50 and capable of discharging the ink to the outside, a tube 92, the upper end of which is connected to the upper discharge portion 91; a lower discharge portion 93 to which a lower end of the tube 92 is connected, which is provided on the casing bottom portion 32, and which can discharge the ink to the outside, and a pump 94 connected to the lower discharge portion 93 and capable of suctioning the ink. The ink discharged from the ejection portion 21 can be discharged to the outside of the casing body 31 by operating the pump 94 in a state in which the contact assembly 50 is in close contact with the ejection portion 21. Incidentally, a casing bottom portion absorber 95 is laid on the casing bottom portion 32.

Referring to FIG. 2, the cap device 30 includes the absorber 41 capable of absorbing the ink ejected from the ejection portion 21 capable of ejecting the ink, and the contact assembly 50 surrounding the absorber 41 and capable of coming into close contact with the ejection portion 21.

Referring to FIGS. 4A and 4B, when the absorber 41 is viewed in the direction facing the facing surface 45, the absorber 41 has a rectangular or substantially rectangular shape. When the contact assembly 50 is separated from the ejection portion 21, the gap G is set between the absorber corner surface 48 and the contact corner surface 56.

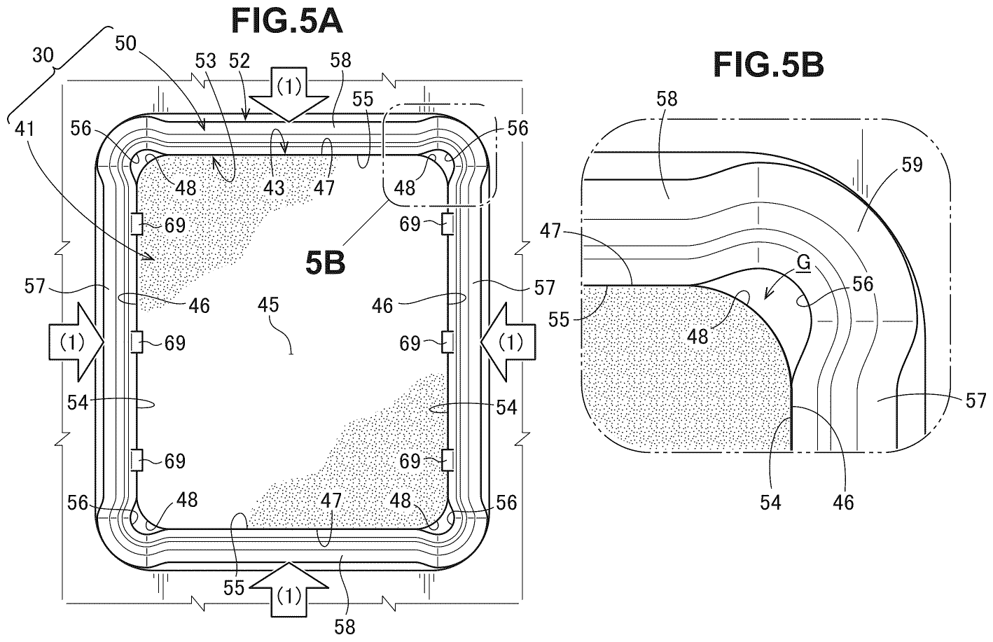

Referring to FIG. 5A, when the contact assembly 50 comes into close contact with the ejection portion 21 and the pump 94 is operated, the internal pressure in a sealed space surrounded by the contact assembly 50 and the ejection portion 21 becomes negative pressure. In the peripheral wall portion 52 of the contact assembly 50, linear portions including the first contact surfaces 54 and 54 are referred to as first side wall portions 57 and 57, and linear portions including the second contact surfaces 55 and 55 are referred to as second side wall portions 58 and 58. As indicated by arrow (1), the first side wall portions 57 and 57 and the second side wall portions 58 and 58 of the contact assembly 50 are deformed to collapse toward the inside of the sealed space.

In a typical cap device, the gap G is not set, and it is difficult for the corners of the contact to deform, and as a result, close contact with the ejection portion is reduced.

In the cap device 30 of the present example embodiment, as illustrated in FIG. 4B, when the contact assembly 50 is separated from the ejection portion 21, the gap G is set in advance between the absorber corner surface 48 and the contact corner surface 56. Since the gap G illustrated in FIG. 4A is set, when the pump 94 is operated, a corner portion 59 (a portion including the contact corner surface 56) of the contact assembly 50 does not come into contact with the absorber corner surface 48, and is therefore easily deformed (see FIG. 5B). The corner portion 59 of the contact assembly 50 can maintain the state of being in close contact with the ejection portion 21. With the above-described configuration, it is possible to provide the cap device 30 including the contact assembly 50 providing very close contact during suction by the pump 94.

Referring to FIG. 4B, both the absorber corner surface 48 and the contact corner surface 56 are curved surfaces. The radius R1 of the absorber corner surface 48 is larger than the radius R2 of the contact corner surface 56. Therefore, when the corner portion 59 of the contact assembly 50 is deformed, the contact assembly 50 is easily and uniformly deformed as a whole. In addition, since the absorber corner surface 48 is a curved surface with the radius R1, the absorber corner surface 48 is smoothly connected to the longitudinal surface 46 and the lateral surface 47, so that the contact surface of the contact assembly 50 is not damaged.

Incidentally, in the cap device 30, a wire mesh may be placed on the facing surface 45 of the absorber 41 in order to reinforce the contact assembly 50. However, when the absorber 41 made of a hard material is adopted, the wire mesh become unnecessary. In the present example embodiment, only the absorber 41 made of a hard material is provided inside the contact assembly 50, and the absorber 41 absorbs ink more easily. Furthermore, since no wire mesh is provided, an increase in the number of components is reduced. Incidentally, the absorbent body made of a hard material means that when the pump 94 is driven and the contact assembly 50 collapses toward the inside of the sealed space, the absorber 41 alone can support the contact assembly 50 without placing a wire mesh.

Incidentally, the present invention is not limited to the example embodiments as long as actions and effects of the present invention are achieved. The contact assembly 50 of the example embodiments has a rectangular or substantially rectangular shape. However, the outer shape of the contact assembly 50 may be a polygonal shape or other suitable shape, for example.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A cap device, comprising:
an absorber to absorb ink ejected from an ejection portion capable of ejecting the ink; and
a contact assembly surrounding the absorber and movable into contact with the ejection portion; wherein
the cap device is configured to suction the ink absorbed in the absorber when the contact assembly is in contact with the ejection portion;
the absorber includes a facing surface to face the ejection portion; and
when the absorber is viewed in a direction facing the facing surface, a gap is defined between a corner of the absorber and a corner of the contact assembly when the contact assembly is separated from the ejection portion.

2. The cap device according to claim 1, wherein
both the corner of the absorber and the corner of the contact assembly are curved surfaces; and
a radius of the corner of the absorber is larger than a radius of the corner of the contact assembly.
